(19) United States
(12) Patent Application Publication
(10) Pub. No.: US 2015/0046783 A1
(43) Pub. Date: Feb. 12, 2015

(54) PRESENTING AN AGGREGATION OF ANNOTATED TERMS IN EBOOK

(71) Applicant: KOBO Incorporated, Toronto (CA)

(72) Inventors: Tony O'Donoghue, Toronto (CA); James Wu, Toronto (CA)

(73) Assignee: KOBO Incorporated, Toronto (CA)

(21) Appl. No.: 13/964,791

(22) Filed: Aug. 12, 2013

(51) Int. Cl. G06F 17/24; G06F 3/0482; G06F 17/22

(52) U.S. Cl. CPC G06F 17/241; G06F 17/2235; G06F 3/0482
USPC 715/205

(57) ABSTRACT

A system and method for providing an annotation summary for key terms in an ebook. An ebook includes pre-selected terms embedded with hyperlinks directing to one or more articles contained by one or more external information sources. Raw information from the one or more articles can be accessed and mapped to respective sections of a wireframe based on the field identifications attached to different segments of the raw information, thereby resulting in an annotation GUI. An annotation summary GUI that encompasses an aggregation of visual objects corresponding to the annotated terms in a book chapter can be presented in response to a user request. A user can select a visual object from the annotation summary GUI to open an annotation GUI for the corresponding term.

### CROSSREFERENCES

The present disclosure is related to: the co-pending patent application titled “DETERMINING KEY EBOOK TERMS FOR PRESENTATION OF ADDITIONAL INFORMATION RELATED THERETO,” filed on Jun. 21, 2013 and Ser. No. 13/924, 339; and the co-pending application titled “PRESENTING EXTERNAL INFORMATION RELATED TO PRESELECTED TERMS IN EBOOK.” The foregoing patent applications are herein incorporated by reference for all purposes.

### TECHNICAL FIELD

The present disclosure relates generally to the field of electronic books, e.g., ebooks, and, more specifically, to the field of ebook presentation and user interfaces with ebooks.

### BACKGROUND

When reading a conventional or an electronic book, a user often encounters interesting or strange terms that he or she wants to have more knowledge about, in addition to what the book itself presents. Mostly likely, the knowledge is readily available on the Internet. For example, online encyclopedia databases, such as Wikipedia, are popular resources that contain a very large amount of information covering almost every conceivable subject matter. Conventionally, the user can find a computing device connected to the Internet, open an internet browser to visit Wikipedia, and then submit his or her search term to get the relevant information on the book term. The user may find the process cumbersome and interruptive and so may give up the intention for a deep dive experience.

“Wikification” refers to the task of automatically linking text-based content to Wikipedia entries corresponding to terms mentioned in the text. Common terms of interest include people, places, organizations and similar categories. Typically a Wikification process involves implementation of two primary steps: (1) detection of suitable candidate terms that are potentially interesting to a user, and (2) disambiguation of some candidate terms that may match to several Wikipedia entries, or webpages.

However, an entry in the Wikipedia or similar information source sites usually includes some segment of information with low relevancy which an average user can hardly find useful even for a deep dive experience. Also, because relevant information may be acquired in more than one entry from either a single or from multiple information sources, presenting these scattered relevant information in its raw form, such as in different pages, inconsistent text formats, and varying categories of content, can make a deep dive experience inefficient and unpleasant.

### SUMMARY OF THE INVENTION

Therefore, it would be advantageous to provide an automatic process for selecting relevant information from linked webpage(s) to annotate a selected term and presenting an on-situ annotation to a user in an organized fashion. It would also be advantageous to provide an automated process for presenting an aggregated overview of the annotated term. Accordingly, embodiments of the present disclosure employ a computer implemented method of rendering an annotation graphic user interface (GUI) that encompasses external information related to a book term in a structured frame. Embodiments of the present disclosure also employ a computer implemented method of rendering an annotation summary GUI that comprises an aggregation of annotated terms in a book chapter or the whole book.

An ebook presented to a user through a reading experience GUI includes pre-selected terms embedded with hyperlinks directing to one or more articles contained by one or more external information sources. Upon a user selecting such a pre-selected term, raw information from the one or more articles can be accessed and fed to a wireframe. The wireframe comprises a plurality of predefined sections arranged in a predetermined layout, where each section defines a field with respect to external information to be included. The raw information is mapped to respective sections of the wireframe based on the field identifications attached to different segments of the raw information. As a result, an annotation GUI, e.g., a stack, including the external information can be displayed in a consistent and orderly format. Therefore, the user can advantageously take the shortcut to acquire additional information related to the preselected term through the annotation GUI. Furthermore, sections with no eligible information provided by the raw information may be hidden from the annotation GUI presentation. Thus, the annotation can be advantageously presented in a single display page that only incorporates very pertinent information to the selected term.

In addition, the reading experience GUI may comprise an icon associated with an annotation summary GUI which includes a list or collection of all the pre-selected terms in a book chapter or the whole book. A user can select a term from the list to access the annotation GUI generated for the term.

In one embodiment of the present disclosure, a computer implemented method of presenting a summary of annotated terms of an electronic book comprises: (1) accessing a list of annotated terms from the electronic book, wherein each annotated term is associated with a respective hyperlink directing to one or more documents from an information source site, wherein the one or more documents comprise summary information with respect to the annotated term; (2) rendering a first graphic user interface (GUI) on a display device, the first GUI comprising an icon associated with an annotation summary GUI; (3) accessing summary information with respect to each annotated term of the list of annotated terms through a respective hyperlink associated therewith; and (4) rendering the annotation summary GUI on the display device in response to a user interaction with the icon, wherein the annotation summary GUI comprises a plurality of visual objects associated with the annotated terms, wherein each visual object comprises summary information with respect to a respective annotated term, and wherein further each visual object is associated with a respective annotation GUI comprising relevant information thereof. The relevant information with respect to a corresponding annotated term comprises summary information with respect to the corresponding annotated term. The summary information may be identified based on field indexes of corresponding one or more documents. The summary information may comprise one or more of an image, the respective term, and a tag indicating a user-viewing history of the corresponding term. The summary information may comprise a sequence of words selected from the corresponding one or more documents if an image is unavailable. The first GUI may be a passage of the electronic book. The list of annotated terms may be pre-selected automatically from a chapter of the electronic book in accordance with a subject of the chapter. The annotation summary GUI may comprise a drop-down menu comprising a menu element. Another annotation summary GUI may be in response to a user interaction with the menu element, wherein another annotation summary GUI comprises another plurality of visual objects corresponding to a different list of terms selected from another chapter of the electronic book. The annotation summary GUI may be downloadable to a non-transitory computer-readable storage medium component associated with the display device in response to a user interaction. The annotation summary GUI may comprise a drop-down menu configured to provide options to sort the plurality of visual objects by different sorting criteria. The annotation summary GUI may be dependent on an operating system associated with the display device.

In another embodiment of present disclosure, a non-transitory computer-readable storage medium embodies instructions that, when executed by a processing device, cause the processing device to perform a method of rendering a term summary display for annotated terms contained in an electronic document that is presented on a display device. The method comprises: (1) accessing a list of annotated terms from the electronic documents, wherein each annotated term is annotated with external information provided by a digital database, wherein the external information comprises summary information identified with an index; (2) rendering a first graphic user interface (GUI) on an electronic device, the first GUI comprising a user-interactive component associated with a term summary GUI; (3) accessing summary information with respect to each annotated term through a hyperlink associated therewith and based on indexes associated with the summary information; and (4) rendering the term summary GUI on the electronic device in response to a user interaction with the user-interactive component, wherein the term summary GUI comprises a plurality of user-interactive objects corresponding to the annotated terms, wherein each of the user-interactive objects comprises at least a portion of summary information with respect to a corresponding annotated term, and wherein further each user-interactive object is associated with a respective annotation GUI comprising external information with respect to the respective term.

In another embodiment of present disclosure, a system comprises: a processor; a communication circuit; and a memory coupled to the processor and comprising instructions that, when executed by the processor, cause the system to perform an automated method of presenting a summary of annotated terms of an electronic book. The method comprising: (1) accessing a list of terms from the electronic book, wherein each term is associated with a respective hyperlink directing to one or more documents from an information source, wherein the one or more documents comprise summary information with respect to the term; (2) rendering a first graphic user interface (GUI) on a display device, the first GUI comprising an icon associated with an annotation summary GUI; (3) accessing summary information with respect to each term of the list of terms through a respective hyperlink associated therewith; and (4) rendering the annotation summary GUI on the display device in response to a user interaction with the icon, wherein the annotation summary GUI comprises a plurality of visual objects associated with the list of terms, wherein each visual object comprises summary information with respect to a respective term, and wherein further each visual object is associated with a respective annotation GUI comprising relevant information with respect to a corresponding term.

This summary contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

Embodiments of the present invention will be better understood from a reading of the following detailed description, taken in conjunction with the accompanying drawing figures in which like reference characters designate like elements and in which:

FIG. 1 is a diagram depicting an exemplary process of presenting a summary list of annotated terms during a user's ebook reading experience and presenting an on-situ annotation upon the user's selection from the summary list in accordance with an embodiment of the present disclosure.

FIG. 2 is a flow chart depicting an exemplary computer implemented method of rendering an annotation summary GUI for an ebook chapter in accordance with an embodiment of the present disclosure.

FIG. 3 is a diagram illustrating exemplary configurations of visual objects representing summary information of annotated terms in an annotation summary GUI in accordance with an embodiment of the present disclosure.

FIG. 4 is a diagram illustrating a configuration of an exemplary annotation summary GUI for a book chapter in accordance with an embodiment of the present disclosure.

FIG. 5 illustrates the drop-down menus and providing options for a user to view the term summaries in different chapters and by different filter criteria in an exemplary annotation summary GUI.

FIG. 6 is a diagram illustrating an exemplary layout configuration of an annotation GUI wireframe that can be implemented on a tablet display device for instance to arrange relevant information obtained from an external information source in accordance with an embodiment of the represent disclosure.

FIG. 7 illustrates an exemplary reading experience GUI, an exemplary annotation summary GUI, and an exemplary annotation GUI that are generated in accordance with an embodiment of the present disclosure.

FIG. 8 is a block diagram illustrating an exemplary computing system including an annotation summary GUI generator in accordance with an embodiment of the present disclosure.

### DETAILED DESCRIPTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail so as not to unnecessarily obscure aspects of the embodiments of the present invention. The drawings showing embodiments of the invention are semi-diagrammatic and not to scale and, particularly, some of the dimensions are for the clarity of presentation and are shown exaggerated in the drawing Figures. Similarly, although the views in the drawings for the ease of description generally show similar orientations, this depiction in the Figures is arbitrary for the most part. Generally, the invention can be operated in any orientation.

### Notation and Nomenclature

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system, or similar electronic computing device, that manipulates and transforms data represented as physical (electronic) quantities within the computer system's registers and memories and other computer readable media into other data similarly represented as physical quantities within the computer system memories or registers or other such information storage, transmission or display devices. When a component appears in several embodiments, the use of the same reference numeral signifies that the component is the same component as illustrated in the original embodiment.

### Presenting an Aggregation of Annotated Terms in Ebook

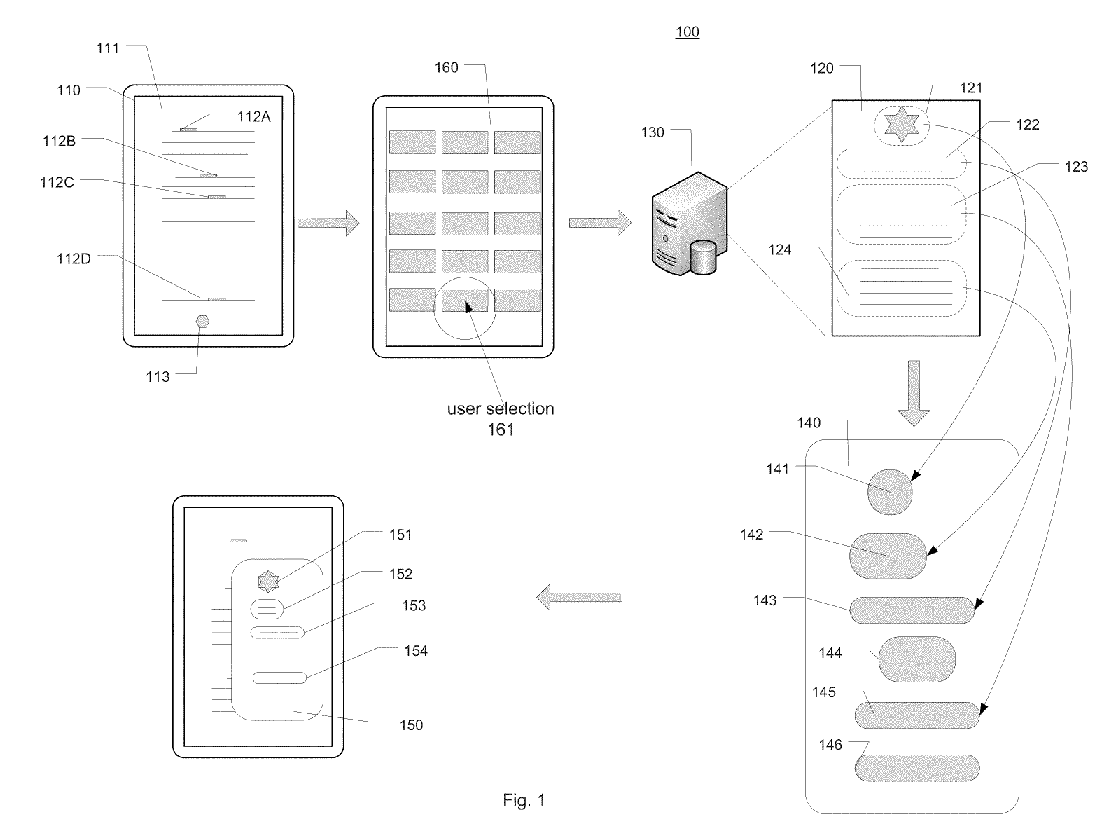

FIG. 1 is a diagram depicting an exemplary process 100 of presenting a summary list of annotated terms during a user's ebook reading experience and presenting an on-situ annotation upon the user's selection from the summary list in accordance with an embodiment of the present disclosure. In FIG. 1, an electronic reader device 110 displays a book page 111 of the ebook in a reading experience graphic user interface (GUI) for example. The presented page encompasses four pre-selected terms 112A-112D displayed with distinctive visual effects or attributes indicative of the availability of annotation. Each preselected term is embedded with one or more hyperlinks directing to one or more documents, e.g., webpages, in an information source site, e.g., Wikipedia.

The reading experience GUI also includes a clickable icon 113 associated with the annotation summary GUI 160. When a user interacts with the icon 113, the annotation summary GUI 160 can be presented in accordance with an embodiment of the present disclosure. In the illustrated example, the icon is a hexagon at the bottom of the display page. It will be appreciated by those skilled in the art that the clickable icon 113 may have any other suitable visual appearance and may be placed in any location in the reading experience GUI.

The annotation summary GUI 160 may comprise a plurality of graphic objects, as represented by the rectangles, displayed in an ordered format, e.g., listing or array display. The graphic objects may comprise summary information, e.g., a brief description and an image, for respective annotated terms mentioned in a book chapter or a whole book for example. Through this summary, a user can advantageously overview all the annotated terms, e.g., that are selected based on relatedness to a topic of a book chapter.

In some embodiments, the graphic objects may also be embedded with the same hyperlinks associated with respective annotated terms. The summary information displayed in each graphic object may be sourced from the one or more documents used for annotation. The summary information may be extracted from the documents based on the field indexes attached to the documents. Once generated, e.g., for a chapter, an annotation summary GUI may be saved to a memory associated with the electronic reader for subsequent access.

In the illustrated example, a user interaction with the graphic object 116 in the summary GUI 160 can prompt the electronic reader 110 to visit the database server 130 for accessing the external information provided by the document 120 via embedded hyperlinks. The document 120 has four segments of information 121, 122, 123, and 124, which may be attached with respective field indexes indicating fields of the information, such as image, overview, history, references, external links, related information, timeline, and etc.

The document 120 is fed to a predefined layout template, for example a wireframe 140, designed to select and organize the external information based on a predetermined pattern. The wireframe 140 may include several sections organized in respective page locations and corresponding to respective fields of information to be populated. The sections in the wireframe 140 may be aligned with field indexes of the webpage to receive information from corresponding fields of the webpage. According to the illustrated example, the wireframe 140 includes 6 sections 141-146, and sections 141, 142, 143 and 145 are populated with information from segments 121, 124, 122, and 123, respectively, through a mapping process. On the other hand, the webpage 120 contains no eligible information for sections 144 and 146 and therefore can be removed from or made invisible in the resultant annotation GUI for the selected term.

Accordingly, the exemplary annotation GUI 150 is generated and comprises four sections of information 151-154 with the content derived from segments 121-124 in the webpage 120 and arranged in a pattern consistent with the wireframe 140. As will be appreciated by those skilled in the art, the annotation GUI window in accordance with the present disclosure can be presented in any suitable fashion. For example, it can overlay on the reading experience GUI and occupy a portion, e.g., approximately about ¾, of the viewing area of the electronic device. The annotation GUI 150 window may initially display a portion of the window and have the means allowing a user to expand the window size or revert back to the reading experience GUI by closing the GUI window.

In some embodiments, once generated for a term, e.g., in response to a user's instruction, an annotation GUI for the term may be saved to a memory associated with the electronic reader. Then the corresponding graphic objects in the annotation summary GUI and the highlighted terms, e.g. 112 A-112D, in the book pages, may be linked to the saved annotation GUIs which can be subsequently accessed directly from the memory and presented to a user without accessing the external information source again.

The present disclosure is not limited to any specific mechanism of identifying terms, or key-terms, for annotation. For instance, the list of the annotation terms may be generated automatically in accordance with relatedness to a topic of a chapter of the ebook. Further, the present disclosure is not limited by any mechanism of mining relevant external information from external information source sites and establishing hyperlinks thereto. In some embodiments, the hyperlinks may result from a wikification process including a disambiguation process.

The preselected terms may comprise any type of expression recognizable by a computer, such as a word, a phrase, a symbol, etc. They may be presented in a page in conjunction with any suitable type of indicative feature or visual attributes, such as a highlight, an underline, a text color, a font, and a combination thereof. In some embodiments, the indicative feature may be designed to be subtle so as not to disturb a user's normal reading experience. In some embodiments, the reading experience GUI may be configured to allow a user to enable or disable the annotation function. If disabled, the indicative features may be concealed and/or the hyperlinks may be deactivated.

It is appreciated that any suitable local or remote database server may act as an information source, to provide pertinent annotation for selected terms in accordance with the present disclosure. Also, any suitable method can be used to retrieve information from an information source for purposes of practicing the present disclosure. More than one information source accessible to a public reader can be used to provide annotation for an ebook by virtue of network connections, e.g. WAN, LAN, or WiFi. To name a few examples, the information website can be any well-known information source, such as Wikipedia, Baidu Baike, Canadian Encyclopedia, Credo Reference, EcuRed, or Grolier Multimedia Encyclopedia. The information sources may contain image, video, or audio content, in addition to text-related content that are presentable on an electronic device.

The present disclosure is not limited to any specific entry point that can lead to generation and display of an annotation GUI. A user may open an annotation GUI by selecting a corresponding clickable object from a display page in a reading experience GUI, from an overview GUI for the book or a chapter of the book, as well as from an annotation summary GUI.

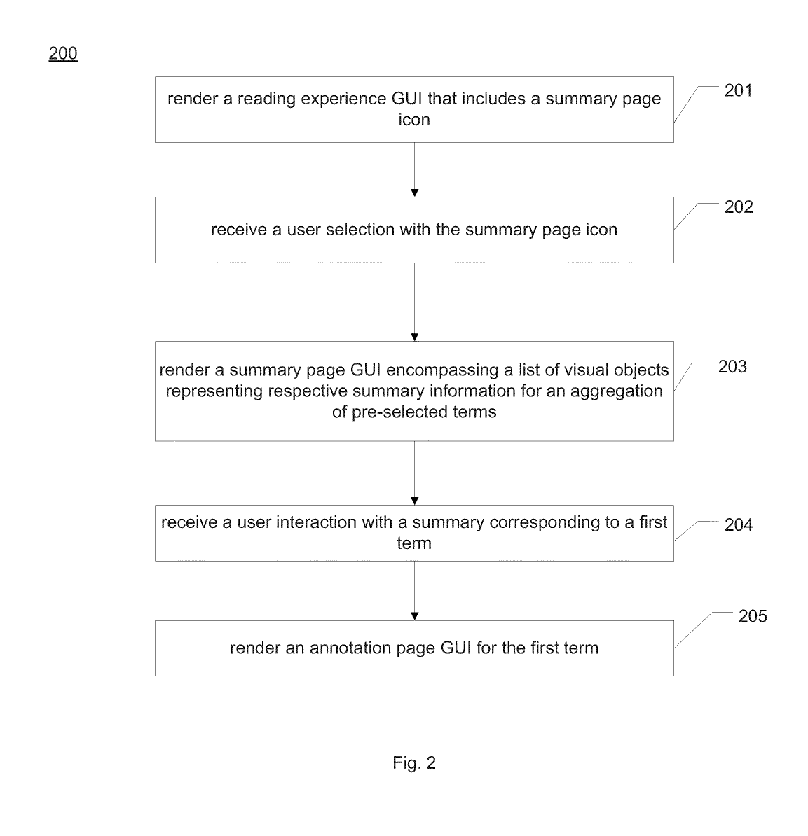

FIG. 2 is a flow chart depicting an exemplary computer implemented method 200 of rendering an annotation summary GUI for an ebook chapter in accordance with an embodiment of the present disclosure. At 201, a GUI comprising an annotation summary page icon associated with the annotation summary GUI is rendered on an electronic reader device. As discussed above, the present disclosure is not limited to any specific entry point that can lead to generation and display of an annotation summary GUI. For example, a user may open an annotation summary GUI by selecting a corresponding clickable object from a reading experience GUI or an overview GUI for the book or a chapter of the book.

At 202, a user interaction with the annotation summary page icon is received at the electronic reader. At 203, the annotation summary GUI is presented, including an aggregation of visual objects corresponding to the respective annotated terms in a book chapter. The visual objects may comprise summary information derived from the documents from an information source site, e.g., Wikipedia. The summary information may be identified from the documents based on the field indexes of the documents and thus derived from one or more fields of the documents, such as the “image” field or the “overview” field.

At 204, a user interacts with the visual object representing a first term, e.g., intending to deep dive the first term. At 205, in response to the user selection, an annotation GUI comprising relevant information for the first term can be generated and displayed on the electronic reader, as discussed in greater detail with reference to FIG. 1.

The computer implemented method 200 can be used in a variety of devices running an electronic book reader software, such as desktop computer, a laptop computers, handheld personal digital assistants (PDAs), a tablet, a smart phones with displays, and so forth.

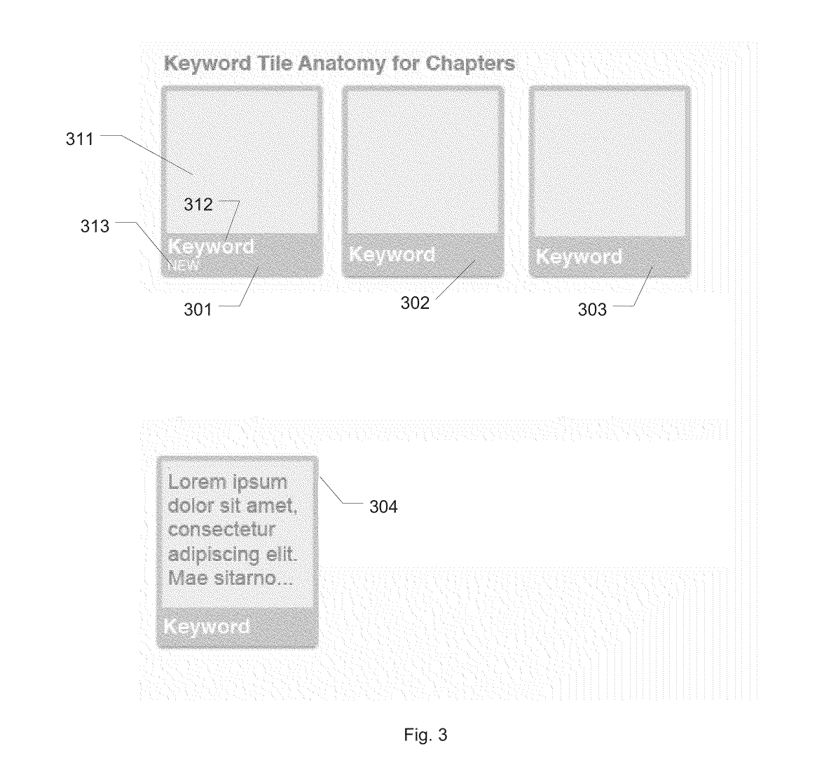

FIG. 3 is a diagram illustrating exemplary configurations of visual objects representing summary information of annotated terms in an annotation summary GUI in accordance with an embodiment of the present disclosure. In the illustrated embodiments, each visual object comprises a keyword tile, e.g., 301, 302, 303, or 304, that is labeled with the term, e.g. 312, to identify the represented term. A tile can comprise a picture 311 representing keyword. Tile 303 also comprises a “New” tag 312 indicating the keyword being new to the chapter. In some embodiments, the tag can be invisible unless the summary view is filtered by chapter. In some embodiments, in the event that a representative image is unavailable in the linked documents, the tile may incorporate the first few words of the introduction description of the keyword, as illustrated in tile 304. Alternatively, a generic image may be included in the visual object if a relevant image is unavailable. It will be appreciated by those skilled in the art that the visual objects may encompass any other type of suitable content related to the corresponding terms. In some embodiments, the types of content included in the visual objects may vary depending on the categories that the term belong to, such as person's name, place, book title, concept, and etc.

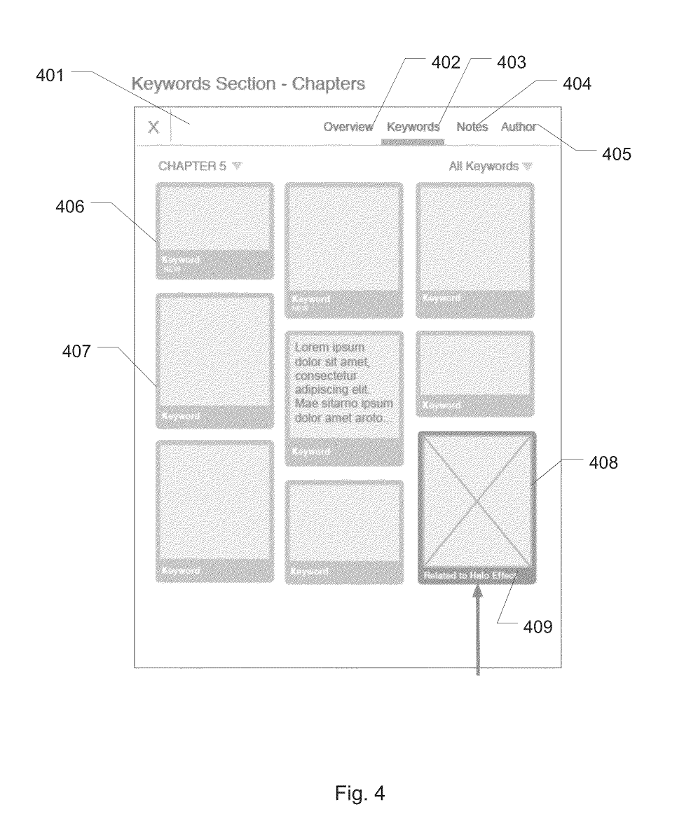

FIG. 4 is a diagram illustrating an exemplary layout of an exemplary annotation summary GUI 400 for a book chapter in accordance with an embodiment of the present disclosure. The annotation summary GUI 400 comprises a header section 401 a plurality of the keyword tiles for key term in the selected chapter, e.g., 406 and 407, and a related book tile 408 representing a related book. The keyword tiles may be arranged in the order which they are mentioned in the book, or any other suitable order. In some embodiments, the annotation summary GUI may provide options for a user to view the tiles in various orders.

In the illustrated embodiment, the header section 401 includes buttons that allow a user to toggle among the annotation summary GUI and other display pages, such as the overview GUI, a notes GUI, and an author GUI. For example, the overview GUI may provide overview information of the chapter or the book. A notes GUI may comprise other users' public comments, e.g., published on social media, regarding the book. The author GUI may comprise external information regarding the author of the book, such as a biography, books authored by him or her, books mentioning the author, or other related information.

The related book tiles 408 may show a book related to the current chapter. A related book may be related to the most mentioned keyword in the chapter, as stated in the text area 409 of the tile. In some embodiments, a related book tile may be shown following every few keyword tiles. It will be appreciated by those skilled in the art that the present disclosure is not limited to any specific layout design of the annotation summary GUI or any other content included therein. Based on the display capability of the device, e.g., depending on an operating system associated with the display device, or the model of a display device and its capabilities, an annotation summary GUI in accordance with the present disclosure may vary and yet perform substantially the same presentation functions.

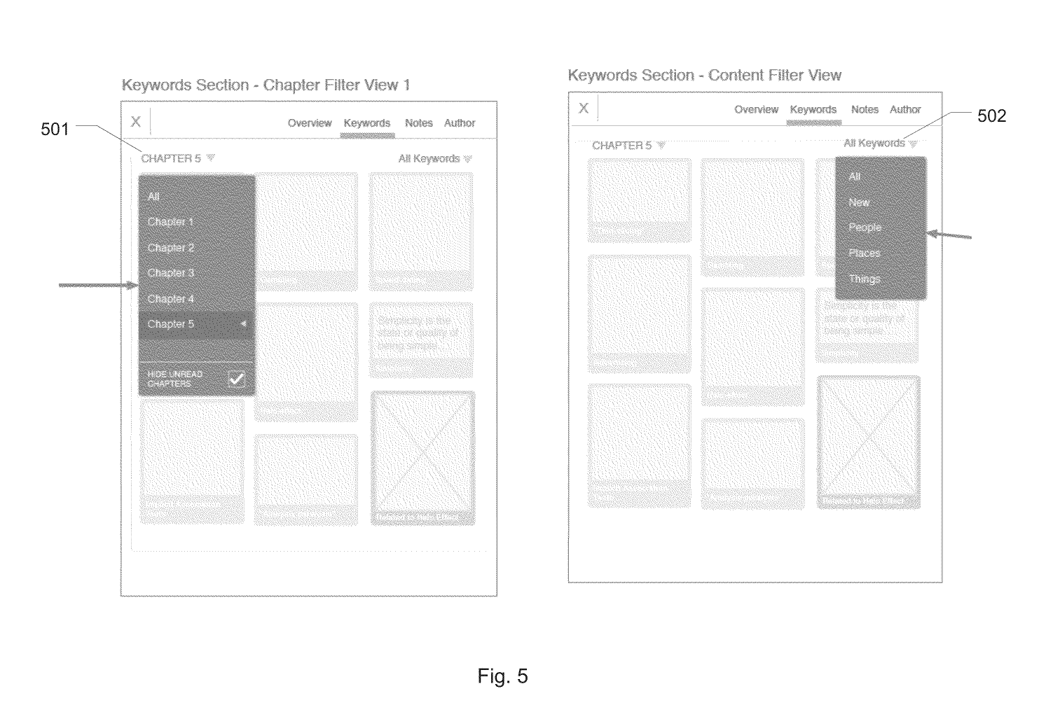

FIG. 5 illustrates the drop-down menus 501 and 502 providing options for a user to view the term summaries for different chapters and by different filter criteria in an exemplary annotation summary GUI 500. By selecting an item in the “Chapter” drop-down menu 501, a user can view the annotated terms mentioned in the corresponding chapter. The menu 501 also allows a user to hide the terms from unread chapters to avoid unwanted revealing of unread book content. By selecting an item in the “Keywords” drop-down menu 502, a user can filter the annotated terms by their categories, such as new, people, places, and things.

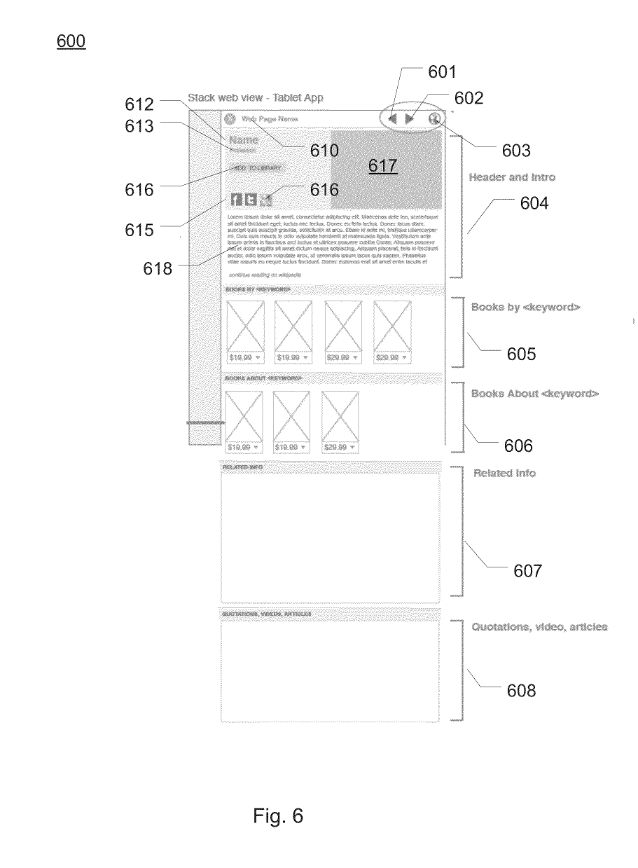

FIG. 6 is a diagram illustrating an exemplary configuration of an annotation GUI wireframe 600 that can be implemented on a tablet display device for instance to arrange relevant information obtained from an external information source in accordance with an embodiment of the represent disclosure. The wireframe 600 can be implemented as part of the ebook software application program on a tablet or any suitable device, for example. In the illustrated example, the wireframe 600 includes several sections labeled as “Header and intro” 604, “Books by <keyword>” 605, “Books About <keyword>” 606, “Related Info” 607, and “Quotation, video articles” 608. Also included are “Back/Forward” buttons 601 and 602 placed on the top edge that allow a user to browse within a web view and open in application browser view button 603.

The “Header and intro” section 604 is placed on the top of the page to receive information regarding the keyword name 612, profession 613, social network links 615, Google map link 614, picture 617, as well as an overview description 618. The “Add to library” button 616 allows a user to save the annotation page to the electronic device for future reference. If the keyword represents a writer's name, the “Books by <keyword>” section 604 may follow the “Header and intro” section 604 include books written by the writer. “Books About <keyword>” section 606 may include books in which the keyword is mentioned or books about the keyword. The “Related Info” 607 may include a few widgets, including notable works by person, influenced by, influenced, peers, tourist attractions near travel places, film about the keyword, and etc. The “Quotation, video articles” section 608 may include quotations, videos, articles, website, and search in Google.

An annotation wireframe may include any additional or different section regarding any suitable type of information that can be provided by any accessible information source. In the illustrated example, the stack wireframe is configured to generate an annotation GUI in a flow view form. However, the present disclosure is not limited to any particular layout. Based on the display capability of the device, e.g., depending on an operation system associated with the display device, or the model of a display device, the wireframe in accordance with the present disclosure can vary and yet perform substantially the same annotation and presentation functions.

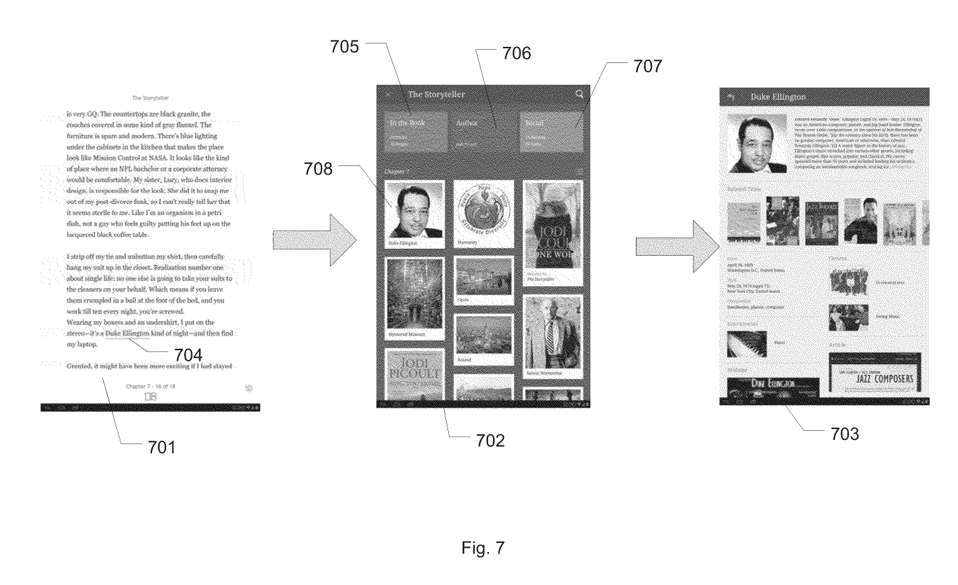

FIG. 7 illustrates an exemplary reading experience GUI 701, an exemplary annotation summary GUI 702, and an exemplary annotation GUI 703 that are generated in accordance with an embodiment of the present disclosure. By selecting a designated icon in the reading experience GUI 701 (not shown explicitly), the user can open the annotation summary GUI 702 for the current chapter. In this example, the summary GUI 702 also includes a “In the book” button associated with an overview page of the book, an “Author” button associated with the a page dedicated to the information related to author of the book, a “Social” button associated with a page presenting related public comments that are posted on a social media website for example.

The reading experience GUI 701 contains an underlined term “Duke Ellington” 704. By selecting the term 704 or the “Duke Ellington” tile 708, the user can open the annotation GUI 703 which may be generated based on a wireframe that is similar with FIG. 3. The annotation GUI 502 displays information derived from a related Wikipedia page in a format defined by the corresponding wireframe. The annotation GUI 502 includes an image, a description of Duke Ellington's life, books related to Duke Ellington's, his biography, related information including genres and instruments, quotations including websites, articles.

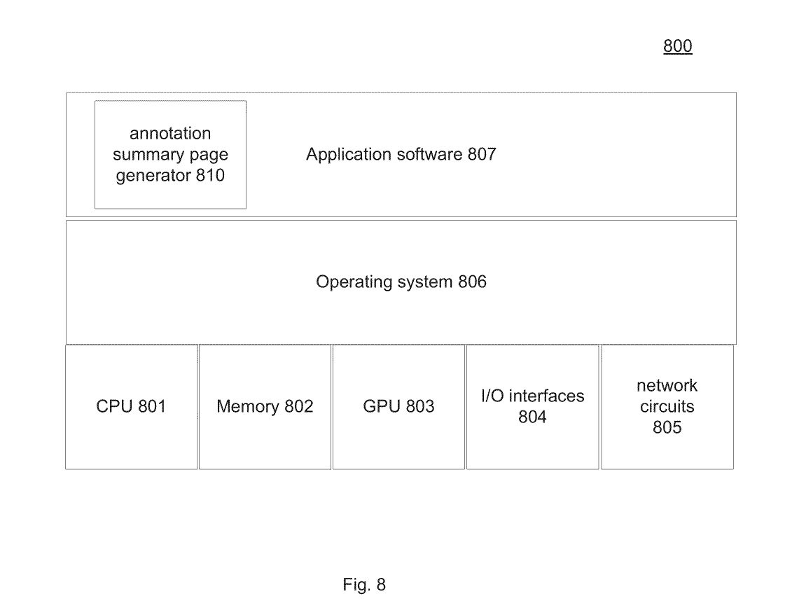

FIG. 8 is a block diagram illustrating an exemplary computing system 800 including an annotation summary GUI generator 810 in accordance with an embodiment of the present disclosure. The computing system 800 comprises a processor 801, a system memory 802, a GPU 803, I/O interfaces 804 and network circuits 805, an operating system 806 and application software 807 including the annotation summary GUI generator 810 stored in the memory 802. When incorporating the user's configuration input and executed by the CPU 801, the annotation summary GUI generator 810 can automatically access external information, process the information through a wireframe, and generate an annotation summary GUI window in accordance with an embodiment of the present disclosure. The annotation summary GUI generator 810 may perform various other functions as discussed in details with reference to FIG. 1-FIG. 4. As will be appreciated by those with ordinary skill in the art, the annotation summary GUI generator 810 can be a functional module integrated in a ebook reading software implemented in any one or more suitable programming languages that are known to those skilled in the art, such as C, C++, Java, Python, Perl, C#, SQL, etc.

Although certain preferred embodiments and methods have been disclosed herein, it will be apparent from the foregoing disclosure to those skilled in the art that variations and modifications of such embodiments and methods may be made without departing from the spirit and scope of the invention. It is intended that the invention shall be limited only to the extent required by the appended claims and the rules and principles of applicable law.

What is claimed is:

1. A computer implemented method of presenting a summary of annotated terms of an electronic book, said method comprising:
accessing a list of annotated terms from said electronic book, wherein each annotated term is associated with a respective hyperlink directing to one or more documents from an information source site, wherein said one or more documents comprise summary information with respect to said annotated term;
rendering a first graphic user interface (GUI) on a display device, said first GUI comprising an icon associated with an annotation summary GUI;
accessing summary information with respect to each annotated term of said list of annotated terms through a respective hyperlink associated therewith; and
rendering said annotation summary GUI on said display device in response to a user interaction with said icon, wherein said annotation summary GUI comprises a plurality of visual objects associated with said annotated terms, wherein each visual object comprises summary information with respect to a respective annotated term, and wherein further each visual object is associated with a respective annotation GUI comprising relevant information thereof.

2. The computer implemented method of claim 1,
wherein relevant information with respect to a corresponding annotated term comprises summary information with respect to said corresponding annotated term,
wherein summary information is identified based on field indexes of corresponding one or more documents, and
wherein further said summary information with respect to said corresponding annotated term comprises one or more of an image, said respective term, and a tag indicating a user-viewing history of said corresponding term.

3. The computer implemented method of claim 2, wherein said summary information comprises a sequence of words selected from said corresponding one or more documents if an image is unavailable.

4. The computer implemented method of claim 1, wherein said first GUI further comprises a passage of said electronic book.

5. The computer implemented method of claim 1, wherein said list of annotated terms are pre-selected automatically from a chapter of said electronic book in accordance with a subject of said chapter.

6. The computer implemented method of claim 5, wherein said annotation summary GUI comprises a drop-down menu comprising a menu element, and further comprising rendering another annotation summary GUI in response to a user interaction with said menu element, wherein said another annotation summary GUI comprises another plurality of visual objects corresponding to a different list of terms selected from another chapter of said electronic book.

7. The computer implemented method of claim 1, wherein said annotation summary GUI is operable to be downloaded to a non-transitory computer-readable storage medium component associated with said display device in response to a user interaction.

8. The computer implemented method of claim 1, wherein said annotation summary GUI comprises a drop-down menu configured to provide options to sort said plurality of visual objects by different sorting criteria.

9. The computer implemented method of claim 1, wherein a layout of said annotation summary GUI is dependent on an operating system associated with said display device.

10. The computer implemented method of claim 1, wherein said rendering display of said annotation summary GUI comprises causing a portion of said annotation summary GUI to overlay on said first GUI partially, causing additional portion of said annotation summary GUI to be visible in response to a user interaction, and closing said annotation summary GUI in response to a user interaction.

11. A non-transitory computer-readable storage medium embodying instructions that, when executed by a processing device, cause the processing device to perform a method of rendering a term summary display for annotated terms contained in an electronic document that is presented on a display device, said method comprising:
accessing a list of annotated terms from said electronic documents, wherein each annotated term is annotated with external information provided by a digital database, wherein said external information comprises summary information identified with an index;
rendering a first graphic user interface (GUI) on an electronic device, said first GUI comprising a user-interactive component associated with a term summary GUI;
accessing summary information with respect to each annotated term through a hyperlink associated therewith and based on indexes associated with said summary information; and
rendering said term summary GUI on said electronic device in response to a user interaction with said user-interactive component, wherein said term summary GUI comprises a plurality of user-interactive objects corresponding to said annotated terms, wherein each of said user-interactive objects comprises at least a portion of summary information with respect to a corresponding annotated term, and wherein further each user-interactive object is associated with a respective annotation GUI comprising external information with respect to said respective term.

12. A non-transitory computer-readable storage medium of claim 11, wherein said list of annotated terms comprise relevant terms that are automatically selected from said electronic book in accordance with a subject of said electronic book.

13. A non-transitory computer-readable storage medium of claim 11, wherein each of said user-interactive objects comprises an image representing a corresponding annotated term, or a selected portion of an introduction paragraph with respect to said corresponding annotated term.

14. A non-transitory computer-readable storage medium of claim 11, wherein said first GUI further comprises an overview of said electronic book, and wherein said term summary GUI further comprises additional user-interactive objects representing related books.

15. A non-transitory computer-readable storage medium of claim 11, wherein said term summary GUI comprises: a first drop-down menu configured to provide options to sort said plurality of user-interactive objects by different sorting criteria; and a second drop-down menu configured to provide options to display summary information for annotated terms from a selected chapter of said electronic book.

16. A system comprising:
a processor,
a communication circuit; and
a memory coupled to said processor and comprising instructions that, when executed by said processor, cause the system to perform an automated method of presenting a summary of annotated terms of an electronic book, said method comprising:
accessing a list of terms from said electronic book, wherein each term is associated with a respective hyperlink directing to one or more documents from an information source, wherein said one or more documents comprise summary information with respect to said term;
rendering a first graphic user interface (GUI) on a display device, said first GUI comprising an icon associated with an annotation summary GUI;
accessing summary information with respect to each term of said list of terms through a respective hyperlink associated therewith; and
rendering said annotation summary GUI on said display device in response to a user interaction with said icon, wherein said annotation summary GUI comprises a plurality of visual objects associated with said list of terms, wherein each visual object comprises summary information with respect to a respective term, and wherein further each visual object is associated with a respective annotation GUI comprising relevant information with respect to a corresponding term.

17. The system of claim 16, wherein each visual object comprises one or more an image or a description line selected from corresponding one or more documents, a respective term associated said visual object, and a tag indicating a user-viewing history of said respective term, and wherein said summary information is identified based on field indexes of one or more documents associated with said respective term.

18. The computer implemented method of claim 16, wherein said list of terms are pre-selected automatically from a chapter of said electronic book in accordance relatedness with a subject of said chapter, and wherein said first GUI further comprises a passage of said electronic book.

19. The computer implemented method of claim 166, wherein said annotation summary GUI is operable to be saved to a memory of said display device in response to a user interaction.

20. The computer implemented method of claim 16, wherein a layout of said annotation summary GUI is dependent on an operating system associated with said display device.
